(19) United States
(12) Patent Application Publication
(10) Pub. No.: US 2004/0075606 A1
(43) Pub. Date: Apr. 22, 2004

(54) Method and system for location estimation analysis within a communication network

(76) Inventors: Jaawa Laiho, Veikkola (FI); Wolfgang Steffens, Veikkola (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/274,983

(22) Filed: Oct. 22, 2002

(51) Int. Cl. G01S 5/14; H04Q 7/20

(52) U.S. Cl. 342/357.1; 342/357.14; 455/446

(57) ABSTRACT

The present invention concerns a system and corresponding method for location estimation analysis within a communication network equipped with location estimation devices adapted to perform a location estimation for terminals, the system comprising reference position determination means (like GPS) adapted to derive reference position information for at least one specific terminal, location information determination means (LCS) adapted to derive location information for said at least one specific terminal, a neural network adapted to correlate said derived reference position information and location information and to output said correlation result.

### FIELD OF THE INVENTION

The present invention relates to a method and system for location estimation analysis within a communication network.

### BACKGROUND OF THE INVENTION

Recently, communication networks have widely spread and are used by a continuously increasing number of subscribers. In order to cope with the increasing number of subscribers and correspondingly the increasing number of terminals of said subscribers which are potentially attached to the network for communication purposes, communication networks have to be most carefully planned in order that the network can be operated smoothly while meeting all requirements of the subscribers.

It is to be noted that the present invention is not limited to a specific type of communication network. It may be for example a wireless communication network such as the UMTS network or any other communication network. Also, network planning is to be understood as a process of setting network operating parameters such as transmit power, antenna characteristics, selection of transmitter sites and/or decision to install further transmitter sites. (A transmitter site in the example of a UMTS network means a Node_B (corresponding to a base station BS in GSM)). In order to effectively perform such a network planning, however, a most properly executed network performance analysis is required, since otherwise network planning would result in a mere “trial and error” process which is cumbersome and rather time consuming, and the success of which is doubtful and can not be verified quantitatively.

The requirements of the users to be met by the communication network can be deemed to be represented by the services the subscribers have subscribed to and among which they may select for communication purposes.

Nowadays, so-called location based services find increasing attention. An example for such a location based service could reside in what is known as driver assist systems: in case of a car accident (e.g. detected by the airbag release) an on-board communication terminal issues an emergency call to an emergency call center and simultaneously informs the position of the car having the accident. Naturally, in order that the emergency call center may send a rescue team to the proper location, it is essential that the location information is as precisely determined and informed as possible.

The first Location Services systems have been meanwhile deployed in the field. A basic system is the cell identifier CI based system. In this system, a terminal may derive its current location on the basis of the cell identifier included in broadcast messages broadcasted from the serving base station (or Node_B). However, the location information in CI based systems has a resolution of cells only which cells may be of a size of several kilometers, for example. CI-based positioning methods are such methods which use the basic CI information and enhance this with i.e. TA (Timing Advance) and RX-level in GSM and RTT (Round trip Time) in WCDMA (Wideband Code Division Multiple Access) case. The basic CI-based systems are for example enhanced by evaluating TA (timing advance) and RX-levels (received signal level) and specially in more advanced system employing triangulation methods such as E-OTD (Enhanced Observed Timing Difference), a lot of optimization and network planning is needed in order to get the system functional.

It is to be noted that Location Services are forming a unique service in the mobile world. Besides the actual services, the different positioning methods in various air-interface standards are one of the key elements of location based services. Each of those positioning methods (such as CI-based, E-OTD, OTDOA (Observed Time Difference of Arrival), A-GPS (Assisted Global Positioning System), TOA (Time of Arrival), AOA (Angle Of Arrival) etc.) has its own characteristic and demands network planning and parameter tuning to achieve optimum results. The location services LCS system must be planned and the network data must be provided to the LCS system. The positioning retrieval from the network is not of such importance in this case.

It seems to be quite difficult to feed such simple network data as configuration information such as, for example, BTS site or antenna coordinates into the LCS system. It might be that the network planning tool has not the capability to store the configuration data or even if for example coordinates are given, they might be incorrect since the network planning tool has no ways to check that the entered coordinates are wrong. It might also be the case that the BTS site is defined rather by landmarks, street crossings etc. than by coordinates.

Overall, the situation might be in many cases, that the coordinates of the BTS or antennas or any other configuration parameters are totally unknown or significant different in the system compared to real life. Those enhanced LCS system (i.e. E-OTD, OTDOA) are utilizing a plurality of BTS (from 3 to upwards) to locate a terminal.

FIG. 1 illustrates on a general level a situation where a location information is determined using three base stations and based on triangulation. The location is determined with a certain measurement error margin and results in that the location is determined as a region of a certain size in which the terminal is located. This location is indicated by the dark area in FIG. 1. Here, it should be noted that location means a region of a certain size (such as a cell or even smaller), whereas a position is intended to define the “point” of location in a more precise manner than a location. Stated in other words, a position information has always a higher resolution compared to the location information. Note further that the actual resolution of position/location varies dependent on the method applied for determination. Nevertheless, a position could in a precise manner be indicated in terms of coordinates (degrees, minutes and seconds) while a location would be indicated as an interval between respective coordinates (the size of the interval then defines the resolution achieved). The position defines the reference data for the system, whereas the location is the actual location estimate provided by the LCS system.

The LCS system can consist of e.g. a Gateway Mobile Location Center GMLC, a Serving Mobile Location Center SMLC, a Location Mobile Unit LMU and supporting functions in the core network (constituted by e.g. Home Location Register HLR, Mobile Services Switching Center MSC and Serving GPRS Support Node SGSN (GPRS=General Packet Radio System)) and radio access network RAN (constituted by e.g. Radio Network Controller RNC, Base transceiver station BTS or base station BS and Base Station Controller BSC). Note that the present invention is not limited to be applied to radio communication systems but could be applied to e.g. any (wireless) systems in which subscriber terminal locations are able to be determined.

In general LCS systems are described in standards defined by the 3^{rd} Generation Partnership Project 3GPP. For example, in the standards 3GPP—TS 02.71; TS 22.071; TS 03.71; TS 23.071, TS 23.171 and other LCS related standards.

There might exist different location methods in one mobile network. Those methods might be described in the above mentioned 3GPP standards or they might be proprietary methods (TOA, AOA, overlay etc.) specific for a network of a certain operator. In general, more advanced methods such as E-OTD and OTDOA require receiving the signals from at least three different BTS sites in order to perform the triangulation calculation, as shown in FIG. 1.

Important to note is that the LCS system is providing the coordinates of the terminals with a certain accuracy only. Now, assuming that one or more of the configuration parameters (for example BTS coordinates, or antenna orientation data) are entered wrong to the LCS system (or entered correctly concerning the numerical value but the numerical value represents the result of an incorrect measurement), the output of the LCS calculation will have always a worse accuracy than predicted/required.

The error will further increase with the increasing number of incorrect configuration settings in the LCS system.

In order to eliminate this error and optimize the performance of the network, intensive network planning must be done and e.g. all BTS coordinates, neighbor base station lists and other configuration settings must be measured correctly and entered in the system correctly.

Therefore the probability of errors in the location estimate increases. At this point of time, there is a urgent need to provide the missing/wrong information to the LCS system. This is currently done by heavy usage of manpower doing field measurements, measuring BTS coordinates, hearable neighbor base stations and tuning system parameters accordingly. Such a procedure is however rather cumbersome, expensive, and whether the results are satisfactory can not be guaranteed.

### SUMMARY OF THE INVENTION

Consequently, it is an object of the present invention to provide an improved method for location estimation analysis within a communication network equipped with location estimation devices adapted to perform a location estimation for terminals, which is free from above mentioned drawbacks.

According to the present invention, the above object is for example achieved by a method for location estimation analysis within a communication network equipped with location estimation devices adapted to perform a location estimation for terminals, the method comprising the step of deriving reference position information for at least one specific terminal, deriving location information for said at least one specific terminal, correlating said derived reference position information and location information using a neural network, and outputting said correlation result.

According to favorable further developments

said derived information is time stamped prior to correlating;

said deriving is performed in regular intervals;

said deriving is performed when needed;

said deriving is triggered by an event/observation;

the method further comprises the steps of measuring the performance for said at least one specific terminal within the network, and supplying the measured performance to said neural network for correlation;

said measuring is performed by said specific terminal;

said measuring is performed by a communication network device;

said correlation result is used to correct a derived location information for an arbitrary terminal different from said specific terminal;

said correlation result is used to change/optimize network configuration.

According to the present invention, the above object is for example achieved by a system for location estimation analysis within a communication network equipped with location estimation devices adapted to perform a location estimation for terminals, the system comprising reference position determination means adapted to derive reference position information for at least one specific terminal, location information determination means adapted to derive location information for said at least one specific terminal, a neural network adapted to correlate said derived reference position information and location information and to output said correlation result.

According to favorable further developments

the system comprises means adapted to accomplish a time stamping of said derived information;

said reference position determination means and said location information determination means are operated in synchronized manners;

said reference position determination means and said location information determination means are operated when needed;

said reference position determination means and said location information determination means are operated as event/observation triggered;

the system comprises measurement means adapted to measure the performance for said at least one specific terminal within the network, and transmission means adapted to supply the measured performance to said neural network.

said measurement means is located at said specific terminal;

said measuring means is part of the communication network;

said correlation result is fed back to said location information determination means to correct a derived location information for an arbitrary terminal different from said specific terminal;

said correlation result is fed back to a network management system to be used to change/optimize network configuration.

By virtue of the present invention, basically the following advantages can be achieved:

the above mentioned drawbacks inherent to the previous solution can be avoided, and more precisely

the combination of LCS-positioning method integration and neural networks as a new way of the LCS deployment reduces efforts for parameter tuning and network data provisioning to the LCS system, thereby saving implementation resources and time,

the proposed method and system, respectively, does not rely on those previous planning methods, rather

by virtue of the invention it is possible to indicate the cells consisting of wrong configuration information,

since specially the errors in the accuracy of the position estimate are static (a BTS will not change its position), it is possible to teach the neural network those estimated position and real position and the neural network will output the differences between these, which in the end leads to the situation of increased accuracy of the position estimate as the output of the neural network can be supplied to the LCS system for enhancing location estimation by error compensation;

furthermore a Quality of position QoP map can be generated, which represents an overview over the communication network area and the precision of the position/location achieved with the LCS system within the respective sub-areas (e.g. cells) of the network;

with the usage of neural networks he need for providing exact LC configuration settings is overcome;

furthermore the proposed method/system can be used in making the positioning related trouble shooting more effective.

### BRIEF DESCRIPTION OF THE DRAWINGS

In the following, the present invention will be described in greater detail with reference to the accompanying drawings, in which

FIG. 1 shows a schematic representation of a location estimation using a triangulation method.

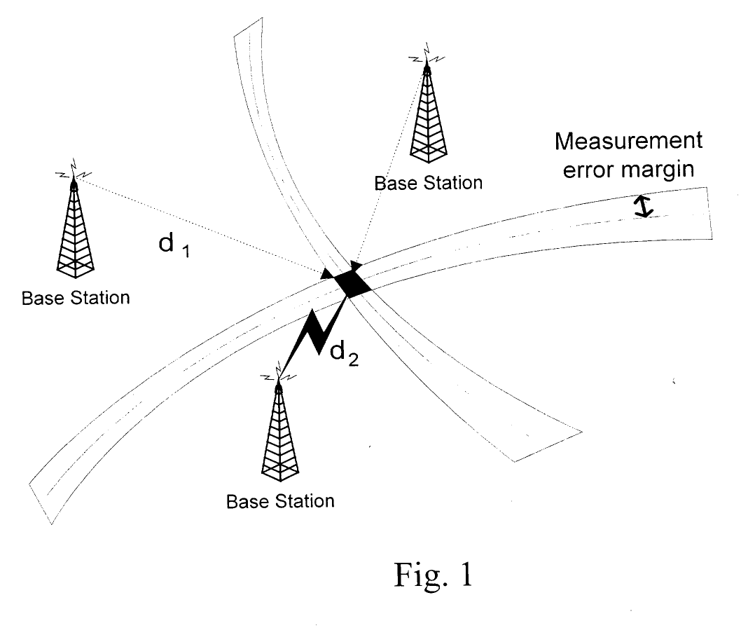

FIG. 2 shows an overview over the system for location estimation analysis within a communication network equipped with location estimation devices adapted to perform a location estimation for terminals operated and configured according to the present invention;

FIG. 3 shows an example of a graphic output of the neural network aiding to identify problem areas within the network.

### DETAILED DESCRIPTION OF THE EMBODIMENTS

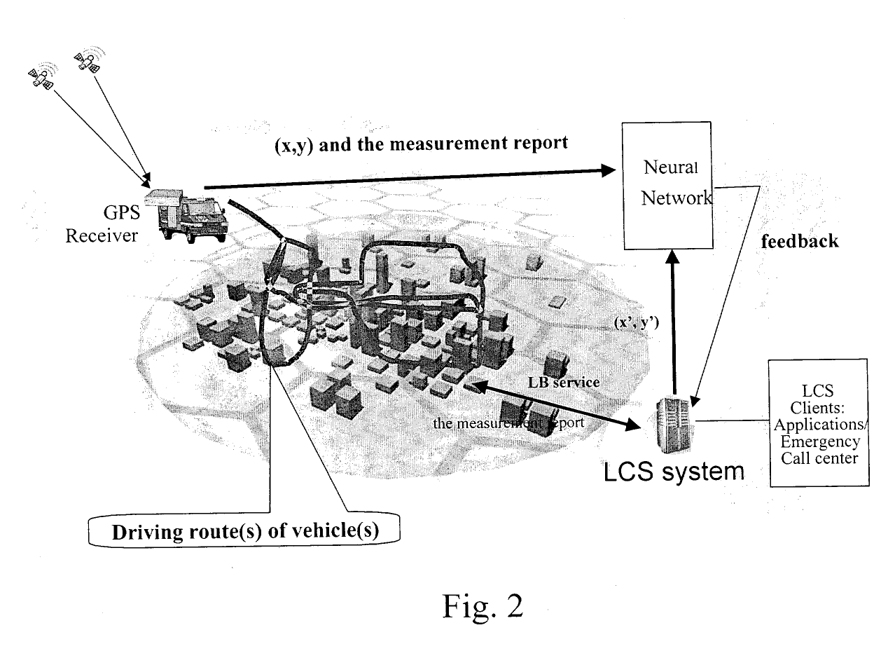

FIG. 2 shows the system for location estimation analysis within a communication network equipped with location estimation devices adapted to perform a location estimation for terminals according to the present invention.

The system comprises reference position determination means adapted to derive reference position information for at least one specific terminal.

These means can be a GPS (Global Positioning System) receiver or a receiver operating using differential GPS in order to further enhance its accuracy. Instead of GPS, a Galileo compatible receiver could be used (Galileo being the “European” version of “GPS”). These systems are satellite based, as indicated in FIG. 2. Nevertheless, also non-satellite based reference position determination means could be used, e.g. bluetooth based ones or wireless local area network WLAN based ones. In any case, the reference position will have to be determined with a different system than the system used for location services.

A corresponding means such as a GPS receiver can be installed to at least one specific vehicle or to a plurality of such vehicles, which will improve the data input amount for a neural network. Such vehicles may for example be taxis, busses or the like which are frequently and or constantly moving within the network area. This is shown in FIG. 2 by the indicated driving route(s) of the vehicle(s).

The vehicles report to the neural network at least the reference position (x, y), and additionally they may submit a measurement report to the neural network (which includes e.g. received signal strength, bit error rate etc.). A measurement report is also submitted to the LCS system, which forward the location estimate (x′, y′) to the neural network. Location information derived by the LCS system is also supplied to LCS clients applications such as an emergency call center, or the like.

The system further comprises a known location information determination means adapted to derive location information for said at least one specific terminal, which operates as for example specified in a respective 3GPP standard.

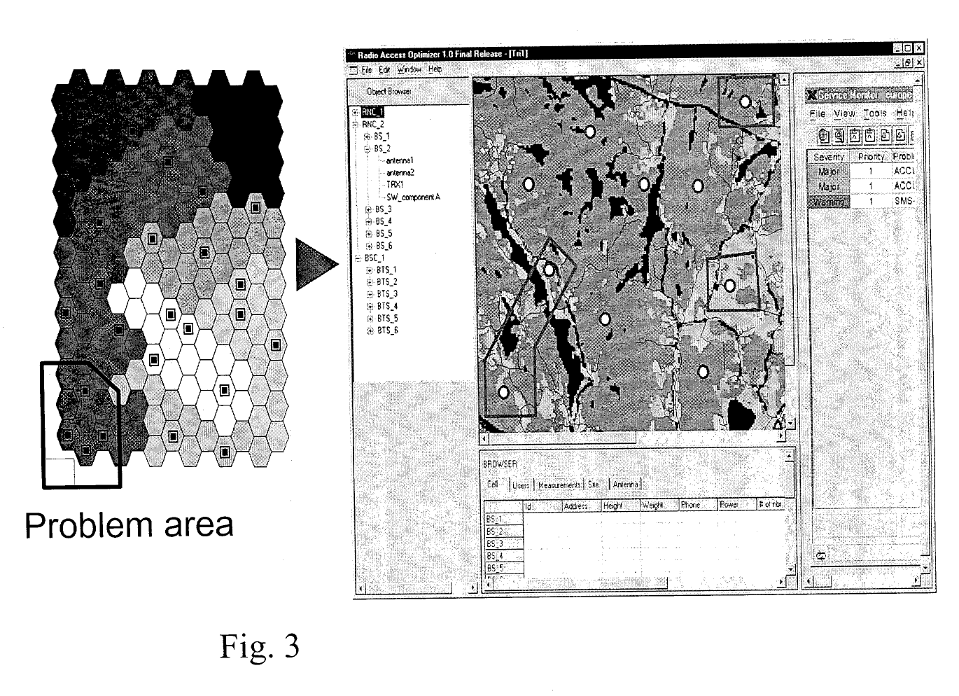

Furthermore, the system comprises a neural network adapted to correlate said derived reference position information and location information and to output said correlation result. The output can be visualized as shown e.g. in FIG. 3 and/or used for further processing. Then, the output of the neural network is supplied as a feedback to e.g. the LCS system, thereby correcting the LCS based location information for an arbitrary communication terminal (different from said specific terminal), or supplied as a feedback to a network management system NMS, thereby supporting network analysis and configuration. An important feature of neural networks in general and of the neural network employed in connection with the present invention is the ability to learn from the environment, and through learning to improve the performance. The purpose of unsupervised (or self organized) learning is to discover significant patters or features in the input data. Neural networks with unsupervised learning are proposed to be used in this invention or any other method alike. An example of such is known as “Self Organizing Map”. The Self-Organizing Map (SOM) is a widely used neural network algorithm, described in greater detail by T. Kohonen, in “The Self-Organizing Map”, Proceedings of the IEEE, Vol. 78, Issue 9, September 1990, pp. 1464-1480. The SOM algorithm maps a high-dimensional data manifold onto a lower-dimensional, usually two-dimensional, grid or display. The SOM has several beneficial features, which make it a useful tool in data mining and exploration. The SOM follows the probability density function of the data and is thus an efficient clustering and quantization algorithm. However, the most important feature of the SOM in data mining is the visualization property. The topology preserving property of the SOM mapping results in a display inherently visualizing the clusters in the data. The SOM based methods have been applied in the analysis of process data, e.g., in steel and forest industry (See for example T. Kohonen, “Analysis of processes and large data sets by a self-organizing method, “Proceedings of the Second International Conference on Intelligent Processing and Manufacturing of Materials”, 1999, vol. 1, pp. 27-36; T. Kohonen, E. Oja, O. Simula, A. Visa, J. Kangas, “Engineering applications of the self-organizing map,” Proceedings of the IEEE, vol. 84, Issue: 10, October 1996, pp. 1358-1384; T. Kohonen, “New developments and applications of self-organizing maps,” Proceedings of International Workshop on Neural Networks for Identification, Control, Robotics, and Signal/Image Processing, 1996, pp. 164-172; J. Ahola, E. Alhoniemi; O. Simula, “Monitoring industrial processes using the self-organizing map,” Proceedings of the IEEE Midnight-Sun Workshop on Soft Computing Methods in Industrial Applications, 1999, pp. 22-27.) Another unsupervised method is for example known as Principle Component Analysis PCA.

This invention does not require a specific method or neural network, but the invention is in general level proposing the use of neural networks, such as unsupervised neural networks (SOM based or PCA based or the like).

Since neural networks are known as such, a detailed description of neural networks is omitted here, while the contents of the above mentioned references is incorporated herein by reference.

The teaching of the neural network takes place such a way, that a terminal (for reference position estimation such as a GPS receiver) would be installed in one or more vehicles, which drive around the area all the time. Those could be e.g. taxi, bus, ambulance, fire truck, delivery trucks etc. The LCS system then starts tracking the devices and e.g. receive regularly location information such as once per minute (it could be also 5 locations per minute or any other ratio which seems suitable). At the same time, the vehicle measures its location with high accuracy, i.e. measures its position, based on satellite systems such as GPS or Galileo, or any other method providing a reference position with greater accuracy than the position/location method adopted by the LCS system in question. Subsequently, the reference position is also simply referred to as GPS based position. The measurements from the LCS system must be time stamped by the satellite system (or vice versa) since the location estimate might arrive at a different point of time in the neural network as the reference position.

FIG. 2 illustrates the teaching process of the neural network. (x,y) are the accurate co-ordinates derived from using a reference method like GPS, while (x′,y′) are the ones estimated by the positioning engine in LCS system.

The neural network receives now constantly (or at least regularly) the position estimate of a specific terminal from the LCS system and the reference position of the specific terminal via a direct connection. The neural network then correlates which position estimate relates to which reference position.

A good/high correlation then indicates that the LCS system in this region of the network works properly and satisfactorily, whereas a poor correlation indicates that e.g. data of the LCS are wrongly configured in the region concerned. Based on the correlation, the poor location estimates can also be corrected without the need to reconfigure the LCS system.

Examples of application for the system in networks are the GERAN (GPRS Enhanced Radio Access Network) system as well as the UTRAN (Universal Terrestrial RAN) system.

GERAN:

Current LCS system integration demands network planning and network data provisioning. This invention overcomes this cumbersome additional work since feedback is provided by self-learning method adopted in the neural network. The feedback (neural network output) can be supplied to the LCS system for location estimate correction and/or to a network management system NMS for network configuration optimization. The configuration optimization can be also directly in the relevant network elements.

In order to achieve this performance, one must have a reference equipment (e.g. a GSM terminal (mobile station MS) or UMTS terminal (user equipment UE) with e.g. GPS capability, or any other means to get accurate reference data), which is sending the real/actual location or position and a standard measurement report to the neural network. (The measurement report includes measurement data related to network performance such as bit error rate BER, signal levels, interference ratios etc.) For the location estimation functionality, the terminal sends the standard measurement report requested by the “LCS-system” to the LCS system. In addition the MS measurement report (MS in active mode) that is send every 480 ms can be used.

Neural networks are needed owing to the fact that there shall be gaps in the data (for example coordinate, location combinations) and this information needs to be derived. Furthermore neural networks can be used to form clusters indicating areas where the exact coordinates and estimated coordinates are in accordance or not in accordance (correlate with each other or not, and the degree of correlation).

Accordingly, the neural network is taught using any combination of the following: the mobile measurement reports and position (x, y), the position/location (x′, y′) generated by the LCS, LCS related configuration information and any measurement retrieved either from the network or from the mobile station.

The SOM-based neural network is used in clustering and different types of areas on SOM can be identified as depicted in FIG. 3. Reasons for clustering can be for example wrong BS co-ordinates in the data base, bad propagation conditions causing degraded QoP, interference etc.

It is to be noted that this clustering is done automatically by SOM being implemented, and the reasoning for the clusters needs to be implemented (programmed by software or hardware) once by an expert.

If new base station BS/Node_B sites are added, the SOM needs some time to be re-taught (or rather re-learned).

UTRAN:

With the currently adopted method, there is a problem that the terminal (UE, MS) has problems in detecting other cells close to a base station, therefore the reliability of the OTDOA method is not high enough for precise location estimation. The problem is amplified if the radio network is planned according to good practices (in terms of capacity and interference control).

Also in this case here, the basic idea and concept of the invention is the same as mentioned above, but in addition to the reference mobile reports and position information, network measurements are included using the terminal trace functionality (one measurement parameter to be used being here downlink connection power, for example). Combined UplinkLink and DownLink information will significantly improve the accuracy, even though it will increase the amount of data to be collected. This trace information can of course be used also in the case of GERAN mentioned above to improve the accuracy.

A way to overcome the vast data amounts is to use this LCS “tuning” only in areas where high QoP is a requirement, so that this can be used selectively according to the need.

In general, reference devices could be installed into taxies, busses, trains that drive around the area a lot and thereby constantly send the data to the system and improve the performance. In the UTRAN case, the number of terminals that can be traced is however limited. Once there are e.g. GPS capable (or Galileo capable) terminal such as MS (customers/subscriber) available, those can be used as “reference device”.

In such cases where the reference position retrieved by e.g. GPS is not available or has bigger inaccuracies than the position measured by the LCS (as this might be the case in indoor environment), other reference positions can be used, like bluetooth based, WLAN aided information etc.

FIG. 3 shows an example of a graphic output of the neural network aiding to identify problem areas within the network. In the left hand portion, the neural network output concerning a certain network area is shown, and in the right hand portion, these information are mapped to a map, thereby illustrating how the neural network is aiding the LCS integration and operation.

It is assumed that all cells in the marked area “problem area” are identified by an SOM based neural network as cells that have wrong configuration data (e.g. like coordinates for the bases stations) in the database. Thus the input information for LCS is wrong and position estimate with bad QoP (Quality of Positioning) can only be obtained. These cells can be depicted on a geographical map and the position on the map can be compared with the coordinates in the database.

In later phases, once the LCS is fully integrated the SOM can be used for providing as an output a QoP map. Conceptually one can assume that the dark gray upper right hand corner is consisting of cells, within which the location can be estimated with 10 m accuracy, a medium gray region of cells with accuracy of location estimation of 35 m and light gray with e.g. 100 m accuracy. Similarly, the position of these cells can be shown on a geographical map.

The SOM tends to collect the cells with similar characteristics/properties into one cluster. Therefore, when one understands that in the case of one cell the positioning is degraded due to interference problems, it is probable that all the cells in the cluster suffer from the same symptom. Thus the troubleshooting is made more effective.

In generation of QoP map, a cell (or sub area of it) needs to be an owner of each set of measurements (for example exact coordinates, LCS estimated coordinates, possible configuration data, the mobile reports, network statistics etc. or any combination of those). It is proposed that the cell within which the position is, is the object owning this information.

As mentioned beforehand, deriving of position and location information is performed in regular intervals, i.e. the respective means are operated in a synchronized manner. Also, the information deriving is performed selectively, i.e. when needed, with the need being for example determined by the network operator (the need may be determined beforehand, e.g. twice per day, every 6 hours, or the like). Alternatively or additionally said deriving is triggered by an event/observation; i.e. for example a certain QoS requirement is not met, or the like.

Accordingly, as has been described herein above, the present invention concerns a system and corresponding method for location estimation analysis within a communication network equipped with location estimation devices adapted to perform a location estimation for terminals, the system comprising reference position determination means (GPS) adapted to derive reference position information for at least one specific terminal, location information determination means (LCS) adapted to derive location information for said at least one specific terminal, a neural network adapted to correlate said derived reference position information and location information and to output said correlation result.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method for location estimation analysis within a communication network equipped with location estimation devices adapted to perform a location estimation for terminals, the method comprising the step of
deriving reference position information for at least one specific terminal,
deriving location information for said at least one specific terminal,
correlating said derived reference position information and location information using a neural network, and
outputting said correlation result.

2. A method according to claim 1, wherein said derived information is time stamped prior to correlating.

3. A method according to claim 1, wherein said deriving is performed in regular intervals.

4. A method according to claim 1, wherein said deriving is performed when needed.

5. A method according to claim 1, wherein said deriving is triggered by an event/observation.

6. A method according to claim 1, further comprising the steps
measuring the performance for said at least one specific terminal within the network, and
supplying the measured performance to said neural network for correlation.

7. A method according to claim 6, wherein
said measuring is performed by said specific terminal.

8. A method according to claim 6, wherein
said measuring is performed by a communication network device.

9. A method according to claim 1, wherein
said correlation result is used to correct a derived location information for an arbitrary terminal different from said specific terminal.

10. A method according to claim 1, wherein
said correlation result is used to change/optimize network configuration.

11. A system for location estimation analysis within a communication network equipped with location estimation devices adapted to perform a location estimation for terminals, the system comprising
reference position determination means (GPS) adapted to derive reference position information for at least one specific terminal,
location information determination means (LCS) adapted to derive location information for said at least one specific terminal,
a neural network adapted to correlate said derived reference position information and location information and to output said correlation result.

12. A system according to claim 11, further comprising means adapted to accomplish a time stamping of said derived information.

13. A system according to claim 11, wherein said reference position determination means and said location information determination means are operated in synchronized manners.

14. A system according to claim 11, wherein said deriving is performed when needed.

15. A system according to claim 11, wherein said deriving is triggered by an event/observation.

16. A system according to claim 11, further comprising
measurement means adapted to measure the performance for said at least one specific terminal within the network, and
transmission means adapted to supply the measured performance to said neural network.

17. A system according to claim 16, wherein
said measurement means is located at said specific terminal.

18. A system according to claim 16, wherein
said measuring means is part of the communication network.

19. A system according to claim 11, wherein
said correlation result is fed back to said location information determination means to correct a derived location information for an arbitrary terminal different from said specific terminal.

20. A system according to claim 11, wherein
said correlation result is fed back to a network management system to be used to change/optimize network configuration.
